(19) United States
(12) Patent Application Publication
(10) Pub. No.: US 2025/0061547 A1
(43) Pub. Date: Feb. 20, 2025

(54) METHOD AND DEVICE FOR IMPROVING IMAGE QUALITY ON BASIS OF SUPER-RESOLUTION NEURAL NETWORK

(71) Applicant: SK Telecom Co., Ltd., Seoul (KR)

(72) Inventors: Mun Kyeong HWANG, Seoul (KR); Hyo Song KIM, Seoul (KR); Jae Ho HUR, Seoul (KR); Jun Ho KIM, Seoul (KR); Hyeong Duck KIM, Suwon-si (KR); Tae Young NA, Seoul (KR)

(21) Appl. No.: 18/938,248

(22) Filed: Nov. 5, 2024

Related U.S. Application Data
(63) Continuation of application No. PCT/KR2022/019384, filed on Dec. 1, 2022.

(30) Foreign Application Priority Data
May 6, 2022 (KR) 10-2022-0056193

(51) Int. Cl. G06T 5/60; G06T 3/4046; G06T 3/4053

(52) U.S. Cl. CPC G06T 5/60; G06T 3/4046; G06T 3/4053; G06T 2207/20081; G06T 2207/20084

(57) ABSTRACT

The present disclosure provides a method and a device for image quality enhancement based on a super-resolution neural network. The present disclosure in at least one embodiment provides an image quality enhancement method optimized for distortion characteristics of a target image, including generating one or more training datasets with one or more distortions, obtaining training distortion characteristic values respectively by inputting the one or more training datasets into a degradation encoder neural network (DEN), obtaining a service distortion characteristic value by inputting a service dataset comprising image patches of the target image into the degradation encoder neural network, computing a similarity between each of the training distortion characteristic values and the service distortion characteristic value, and selecting the training dataset having the highest similarity to the service distortion characteristic value.

### CROSS-REFERENCE TO RELATED APPLICATION

The present application is a bypass continuation of International Application No. PCT/KR2022/019384, filed Dec. 1, 2022, which is based upon and claims priority to Korean Patent Application No. 10-2022-0056193 filed on May 6, 2022. The entire disclosure of the above application is incorporated herein by reference.

### TECHNICAL FIELD

The present disclosure in some embodiments relates to a method and a device for image quality enhancement based on a super-resolution neural network.

### BACKGROUND

The statements in this section merely provide background information related to the present disclosure and do not necessarily constitute prior art.

Based on an image quality enhancement model, a low-quality image can be converted to a high-quality image. The image quality enhancement model can be trained based on machine learning that is based on artificial neural networks. To train an image quality enhancement model, sufficient data for supervised learning on distortion is required. Here the distortion means blur, noise, and so on found in low-quality image. One way of collecting data for supervised learning is to manually convert low-quality data into high-quality data. This method is quite expensive. Depending on the service environment that provides image, it may not be able to collect data for supervised learning in the first place.

To generate data for supervised learning, prior art randomly adds distortions such as blur, noise, and compression to the target image to collect data for supervised learning. This method is a universal method that can be applied to any image, but it has the issue of generating data for supervised learning that fails to focus on distortion characteristics reflected exclusively in the target image.

Meanwhile, an image quality enhancement model trained based on a dataset with various distortion characteristics reflected has a deficiency in that it is not optimized for converting a target image into a high-quality image because it is not sufficiently trained on distortion characteristics reflected exclusively in the target image.

### SUMMARY

According to one embodiment of the present disclosure, an image quality enhancement device can select training dataset with distortions most similar to the distortion characteristics of a service dataset of the target image by calculating a similarity between each of the distortion characteristic values of the training datasets and the distortion characteristic value of the service dataset.

According to one embodiment of the present disclosure, an image quality enhancement device can select a super-resolution neural networks that are optimized for a certain distortion based on a similarity between the distortion characteristic values.

The problems to be solved by the present invention are not limited to those mentioned above, and other problems not mentioned will be apparent to those of ordinary skill in the art from the following description.

At least one aspect of the present disclosure provides an image quality enhancement method optimized for distortion characteristics of a target image, the image quality enhancement method including generating one or more training datasets with one or more distortions, obtaining training distortion characteristic values respectively by inputting the one or more training datasets into a degradation encoder neural network (DEN), obtaining a service distortion characteristic value by inputting a service dataset comprising image patches of the target image into the degradation encoder neural network, computing a similarity between each of the training distortion characteristic values and the service distortion characteristic value, and selecting the training dataset having a highest similarity to the service distortion characteristic value.

Another aspect of the present disclosure provides an image quality enhancement method optimized for distortion characteristics of a target image, the image quality enhancement method including training, by using training datasets with different distortions, one or more super-resolution neural networks (SRNs) to be respectively optimized for a certain distortion, computing, by using a degradation encoder neural network (DEN), a similarity between a service dataset and each of the training datasets that are applied respectively to the one or more super-resolution neural networks, selecting, among the one or more super-resolution neural networks, a super-resolution neural network trained with a training dataset having a highest similarity, and, converting the target image into a high-quality image by using the selected super-resolution neural network.

Yet another aspect of the present disclosure provides an image quality enhancement device optimized for distortion characteristics of a target image, the image quality enhancement device including a memory configured to store one or more instructions, and a processor, wherein the processor is configured to execute the one or more instructions for performing the steps of: training, by using training datasets with different distortions, one or more super-resolution neural networks (SRNs) to be respectively optimized for a certain distortion; computing, by using a degradation encoder neural network (DEN), a similarity between a service dataset and each of the training datasets that are applied respectively to the one or more super-resolution neural networks; selecting, among the one or more super-resolution neural networks, a super-resolution neural network trained with a training dataset having a highest similarity; and converting the target image into a high-quality image by using the selected super-resolution neural network.

The present disclosure in some embodiments trains a super-resolution neural network based on the training dataset with the highest similarity, enabling to convert the target image into a high-quality image by using the super-resolution neural network optimized for the target image.

The present disclosure in some embodiments calculates a similarity between the distortion characteristics of each of the training datasets and the distortion characteristics of the service dataset, enabling to select, from among the pre-trained super-resolution neural networks, a super-resolution neural network trained focusing on the distortion characteristics of the target image.

The effects of the present disclosure are not limited to those mentioned above, and other unmentioned effects will be apparent to those of ordinary skill in the art from the above description.

### BRIEF DESCRIPTION OF THE DRAWINGS

FIG. 1A is a flowchart of an image quality enhancement method according to at least one embodiment of the present disclosure.

FIG. 1B is a flowchart of an image quality enhancement method, according to another embodiment of the present disclosure.

FIG. 2 is a diagram illustrating the process of generating a training dataset, according to at least one embodiment of the present disclosure.

FIG. 3 is a diagram illustrating a process of training a super-resolution neural network, according to at least one embodiment of the present disclosure.

FIG. 4 is a diagram illustrating a process of feeding a service dataset into a degradation encoder neural network to extract distortion characteristics, according to at least one embodiment of the present disclosure.

FIG. 5A is a diagram illustrating a process of calculating weights based on a similarity between a training dataset and a service dataset, according to at least one embodiment of the present disclosure.

FIG. 5B is a diagram illustrating an example training dataset according to at least one embodiment of the present disclosure.

FIG. 6 is a block diagram of an image quality enhancement device according to at least one embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

Hereinafter, the term ‘image’ may refer to a still image or a moving image (i.e., video).

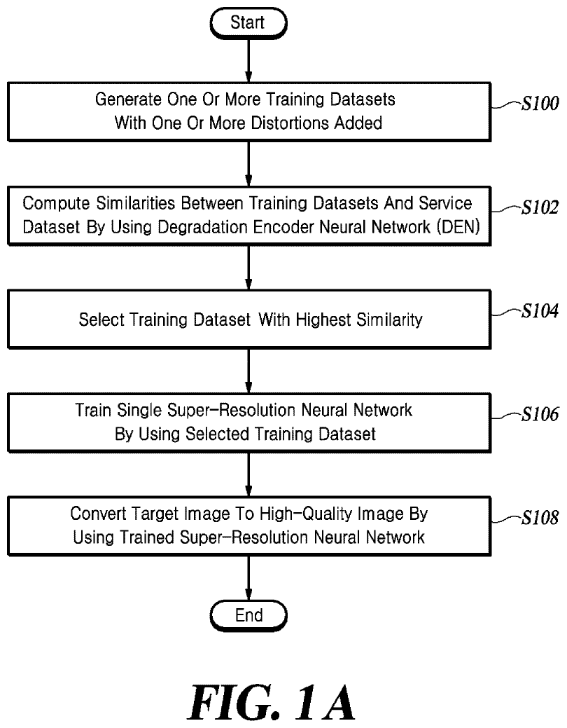

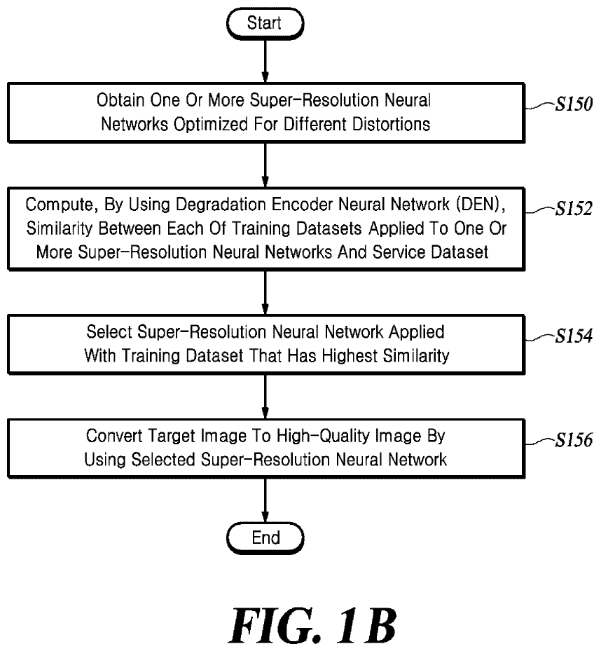

FIG. 1A is a flowchart of an image quality enhancement method according to at least one embodiment of the present disclosure.

Referring to FIG. 1A, the image quality enhancement device may generate one or more training datasets to which one or more distortions are added (S100). Here, the distortions include blur, noise, and the like. The method of adding the distortions may include adding a single distortion characteristic at a certain ratio or adding a combination of two or more distortion characteristics at a certain ratio each. A training dataset refers to one or more image patches included in a training image and is categorized into a single training set.

The image quality enhancement device may compute a similarity (Score) between each of the distortion characteristic values of the training datasets and the distortion characteristic value of a service dataset (S102). Here, the service dataset refers to one or more image patches that constitute target images to be subjected to image quality enhancement and are categorized into a single service set.

The image quality enhancement device may obtain a distortion characteristic value of each dataset by using a degradation encoder neural network (DEN). Here, the degradation encoder neural network is a neural network that outputs a characteristic value of a distortion contained in an input image. The output of the degradation encoder neural network is a vector that is clustered by the distortion characteristics and intensity of the input image. The degradation encoder neural network may be trained based on contrastive learning. Contrastive learning is a method of training a target by using an objective function designed to minimize loss between image patches with the same distortion and maximize loss between image patches with different distortions. Contrastive learning uses a first objective function (L_{DEN}) to train the degradation encoder neural network. The first objective function may be expressed by using Equation 1.

$${L}_{D E N} = {\sum }_{m = 1}^{{N}_{d e g}} - log \frac{exp ( D E N ( {p}_{m , 1} ) \cdot DE N ( {p}_{m , 2} ) / ϵ )}{{\sum }_{n = 1}^{{N}_{n e g}} exp ( D E N ( {p}_{m , 1} ) \cdot DE N ( {p}_{∼ m , n} ) / ϵ )} \qquad [ Equation 1 ]$$

Here, DEN(⋅) represents the output of the degradation encoder neural network, N_{deg} is the total number of different distortions to be learned, and p_{m,1} and p_{m,2} are the query sample and positive sample, respectively, corresponding to the image patch to which the m-th distortion is added. An image patch is one image among a plurality of images that make up a dataset. p_{˜m,n} is the negative samples corresponding to the image patches to which the non-m-th distortions are added, and N_{neg} is the total number of negative samples. When training the degradation encoder neural network by using contrastive learning, the larger the number of negative samples, the more stable the training can be achieved.

The image quality enhancement device may input one or more training datasets and a service dataset respectively into the degradation encoder neural network. Based on the output of the degradation encoder neural network, the image quality enhancement device may obtain a distortion characteristic value of each of one or more training datasets and a distortion characteristic value of the service dataset.

A similarity between the distortion characteristic value of any of the training datasets and the distortion characteristic value of the service dataset may be calculated by using Equation 2.

$$Score = {‖ {\sum }_{l = 1}^{{N}_{s p}^{g}} D E N ( {x}_{l}^{g} ) / {N}_{s p}^{g} - {\sum }_{k = 1}^{{N}_{s p}^{s}} D E N ( {x}_{k}^{s} ) / {N}_{s p}^{s} ‖}_{1} \qquad [ Equation 2 ]$$

Here, Nₛₚ^{g} is the total number of representative samples of the training dataset, and Nₛₚ^{s} is the total number of representative samples of the service dataset.

Since it is inefficient to compute similarity based on all samples in a dataset, representative samples of each dataset may be extracted in advance. The approach for extracting representative samples of the data includes randomly sampling from the dataset or selecting representative images per cluster by using K-means clustering.

In Equation 2, Σₗ₌₁^{N}^{ₛₚ}^{^{g}} DEN(xₗ^{g})/Nₛₚ^{g}, which is the average of the distortion characteristic values for one or more samples selected from each training dataset, may be used as a value representing the distortion characteristic of each training dataset (as the training distortion characteristic value, hereinafter). Such training distortion characteristic value may be interpreted as a value representing a distortion characteristic that can be best reconstructed by a super-resolution neural network to be trained by using the corresponding training dataset. Further, Σₖ₌₁^{N}^{ₛₚ}^{^{s}} DEN(xₖ^{s})/Nₛₚ^{s}, which is an average of the distortion characteristic values for one or more samples selected from the service set, may be utilized as a value representing the distortion characteristic of the service dataset (as the service distortion characteristic value, hereinafter). The image quality enhancement device may pre-calculate a training distortion characteristic value for each of the one or more training datasets, and generate a lookup table arranging the calculated training distortion characteristic values in the form of a table.

The image quality enhancement device may select a training dataset with the highest similarity to the service distortion characteristic value (S104). The reason for selecting the training dataset with the highest similarity is that the selected training dataset can be used to train a super-resolution neural network to be optimized for the distortion characteristics of the target image.

The image quality enhancement device may train a single super-resolution neural network (SRN) based on the selected training dataset (S106).

The image quality enhancement device may convert the target image to a high-quality image by using the super-resolution neural network trained based on the selected training dataset (S108).

FIG. 1B is a flowchart of an image quality enhancement method according to another embodiment of the present disclosure.

Referring to FIG. 1B, the image quality enhancement device may have obtained one or more super-resolution neural networks optimized for different distortions (S150). The image quality enhancement device may generate one or more training datasets optimized for different distortions. The image quality enhancement device may use the training datasets to train one or more super-resolution neural networks. Each of one or more super-resolution neural networks may be equivalent to a super-resolution neural network optimized for a certain distortion.

The image quality enhancement device may compute, by using the degradation encoder neural network, a similarity between each of the training datasets applied to one or more super-resolution neural networks and the service dataset (S152). For example, the image quality enhancement device may obtain, by using the degradation encoder neural network, a training distortion characteristic value, which is a value representing a distortion characteristic of the training dataset applied to each super-resolution neural network, and a service distortion characteristic value, which is a value representing a distortion characteristic of the service dataset. Here, the training distortion characteristic value may be an average of the outputs of the degradation encoder neural network for one or more samples selected from each training dataset, and the service distortion characteristic value may be an average of the outputs of the degradation encoder neural network for one or more samples selected from the service dataset. The image quality enhancement device may have pre-calculated and stored in the form of a lookup table the training distortion characteristic values of the training datasets applied to the super-resolution neural networks, respectively. The image quality enhancement device may compute a similarity based on a difference between the training distortion characteristic value corresponding to each super-resolution neural network and the service distortion characteristic value.

The image quality enhancement device may select, among the one or more pre-trained super-resolution neural networks, a super-resolution neural network applied with the training dataset that has the highest similarity to the service dataset (S154).

The image quality enhancement device may convert the target image to a high-quality image by using the selected super-resolution neural network (S156).

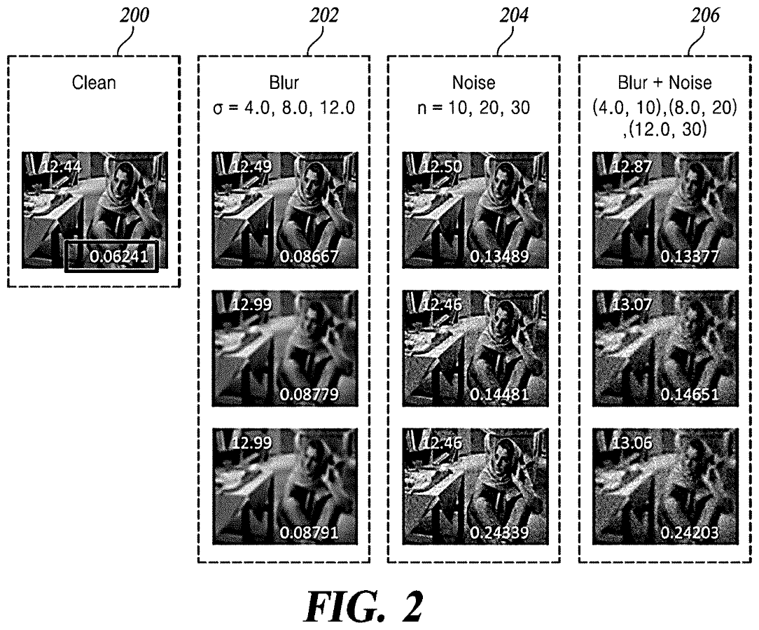

FIG. 2 is a diagram illustrating the process of generating a training dataset, according to at least one embodiment of the present disclosure.

Referring to FIG. 2, the image quality enhancement device may add distortions to a training image's original copy 200. The image quality enhancement device may generate a training dataset 202 with blur added to the training image's original copy 200, a training dataset 204 with noise added to the original copy 200, and a training dataset 206 with both blur and noise added. The image quality enhancement device may generate the plurality of training datasets 202, 204, and 206 by combining blur and noise at different intensities.

The image quality enhancement device may train the super-resolution neural networks based on the training datasets focused on the distortion characteristics of the target image by generating training dataset with added distortions similar to the distortion characteristics of the target image.

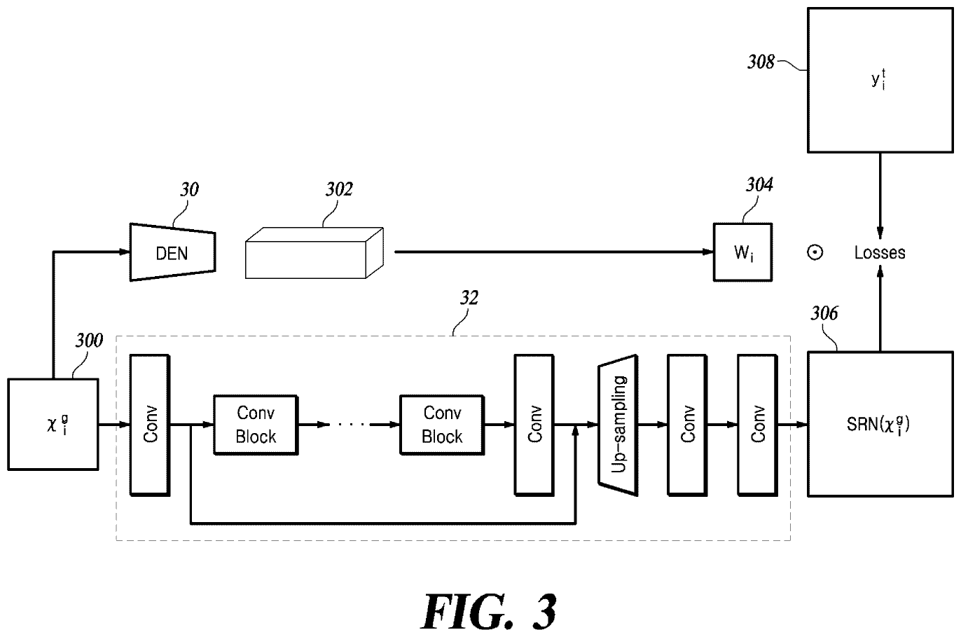

FIG. 3 is a diagram illustrating a process of training a super-resolution neural network, according to at least one embodiment of the present disclosure.

Referring to FIG. 3, the image quality enhancement device may input a training image 300 added with an arbitrary distortion to a degradation encoder neural network 30 to obtain a training distortion characteristic value 302 and input the training image 300 to a super-resolution neural network 32 to obtain an output image 306.

The image quality enhancement device may compute a second objective function based on the difference between the output image 306 and a desired image 308. The second objective function is a function for training a super-resolution neural network (SRN). The second objective function may have a weight 304 applied thereto, which is derived based on the training distortion characteristic value 302. The second objective function may be expressed as shown in Equation 3.

$${L}_{S R N} = {𝔼}_{{x}_{i}^{g} , {y}_{i}^{t}} {‖ {w}_{i} ⊙ ( SRN ( {x}_{i}^{g} ) - {y}_{i}^{t} ) ‖}_{1} \qquad [ Equation 3 ]$$

Here, xᵢ^{g} is the low-quality training image 300 with arbitrary distortion added, SRN(xᵢ^{g}) is the output image 306 of the degradation encoder neural network, yᵢ^{t} is the desired high-quality image 308 that serves as the objective for the image quality enhancement, and the subscript i means the i-th sample in the training batch. wᵢ means a weight.

The weight may be determined based on the similarity between the training image 300 in the training dataset and the target image in the service dataset and may be expressed by using Equation 4.

$${w}_{i} = \frac{exp {‖ DE N ( {x}_{i}^{g} ) - {\sum }_{k = 1}^{{N}_{s p}} D E N ( {x}_{k}^{s} ) / {N}_{s p} ‖}_{1}}{{\sum }_{j = 1}^{{N}_{b c}} exp {‖ DE N ( {x}_{j}^{g} ) - {\sum }_{k = 1}^{{N}_{s p}} D E N ( {x}_{k}^{s} ) / {N}_{s p} ‖}_{1}} \qquad [ Equation 4 ]$$

Here, N_{bc} is the total number of samples in the training batch, and Nₛₚ is the total number of representative samples of the service dataset.

Since it is computationally burdensome to consider all the images in the service dataset when calculating the weight, Nₛₚ samples may have been obtained, representing the service dataset. The method of extracting Nₛₚ samples may include randomly sampling from the service dataset or selecting and sampling representative images per cluster by using a K-means clustering algorithm.

Σₖ₌₁^{N}^{ₛₚ} DEN(xₖ^{s})/Nₛₚ may be interpreted as a value representing distortion characteristics of the service dataset. The image quality enhancement device may have pre-calculated Σₖ₌₁^{N}^{ₛₚ} DEN(xₖ^{s})/Nₛₚ for a particular service dataset and stored it in a lookup table.

The image quality enhancement device may train the super-resolution neural network by using the second objective function generated based on operation the weights 304 and the difference between the output image 306 and the desired image 308. As described above, according to at least one embodiment of the present disclosure, the similarity between the training dataset and the service dataset may be reflected as a weight in the error backpropagation process.

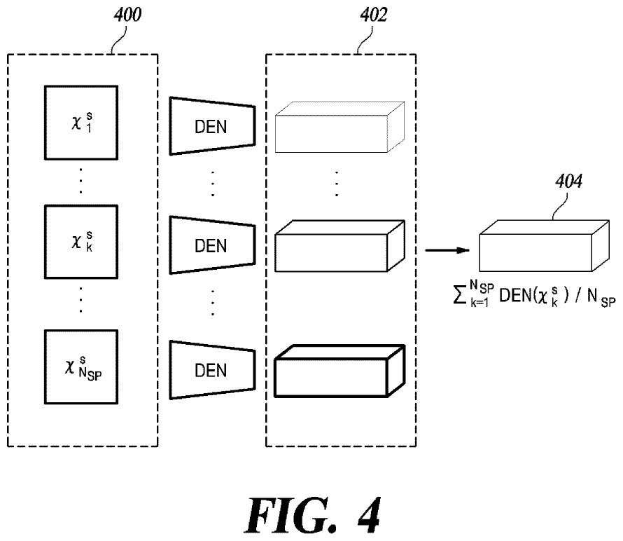

FIG. 4 is a diagram illustrating a process of feeding a service dataset into a degradation encoder neural network to extract distortion characteristics, according to at least one embodiment of the present disclosure.

Referring to FIG. 4, the image quality enhancement device may input samples 400 extracted from the service dataset into degradation encoder neural networks before training super-resolution neural networks and thereby obtain service distortion characteristic values 402. The service distortion characteristic values 402 may be represented as vector values of (1×N), where N is a natural number. The image quality enhancement device may calculate an average 404 of the service distortion characteristic values based on the respective service distortion characteristic values 402. The average of the service distortion characteristic values 404 may be a value representative of the distortion characteristics of the service dataset.

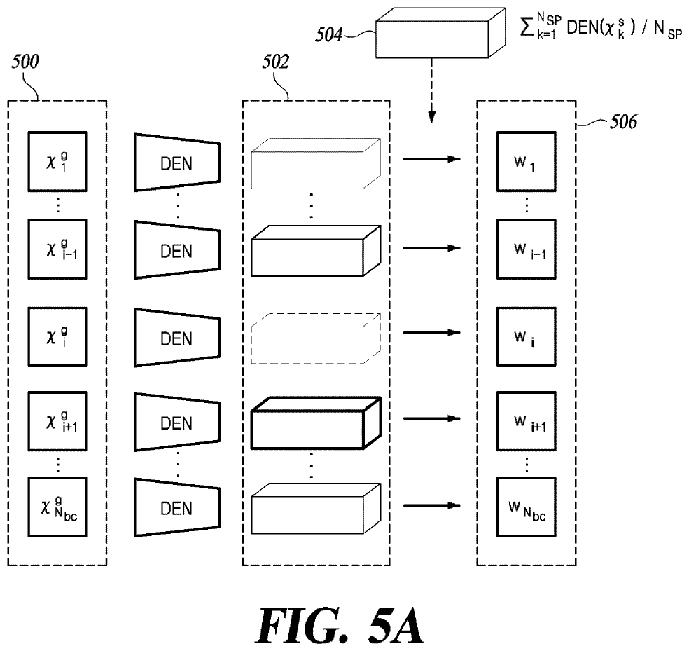

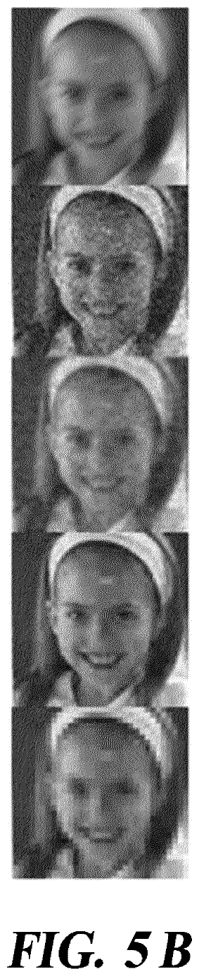

FIG. 5A is a diagram illustrating a process of calculating weights based on a similarity between a training dataset and a service dataset, according to at least one embodiment of the present disclosure.

FIG. 5B is a diagram illustrating an example training dataset according to at least one embodiment of the present disclosure.

Referring to FIG. 5A, the image quality enhancement device may input each of the image patches of a training dataset 500 into degradation encoder neural networks and thereby obtain a training distortion characteristic value 502 for the training of each image. Here, the image patches of the training dataset 500 may have different distortions added to them, as shown in FIG. 5B. The training distortion characteristic value 502 may be represented as a vector value of (1×N), where N is a natural number. The image quality enhancement device may calculate a weight 506 of the training dataset based on a similarity between the training distortion characteristic value 502 and the average 504 of the service distortion characteristic values.

In the present disclosure, similarity may be utilized in two ways. The first way, as described in FIG. 3, is to calculate a weight for each sample in the training dataset based on the similarity and incorporate it into the error backpropagation process for the super-resolution neural network.

A second method of utilizing similarity is to select one of a plurality of super-resolution neural networks or a plurality of training datasets based on similarity, as described above in FIGS. 1A and 1B. If the data to be provided to a service is specifically determined, there is no need to train all the super-resolution neural networks, and it may be efficient to train only one super-resolution neural network based on the training dataset with the highest similarity, as shown in FIG. 1A. For example, to select a dataset whose distortion is most similar to the distortion characteristic value of the target image, the present disclosure may calculate the similarity for each of the plurality of datasets. By comparing the calculated similarities among themselves, the dataset corresponding to the highest similarity may be selected to train a single super-resolution neural network.

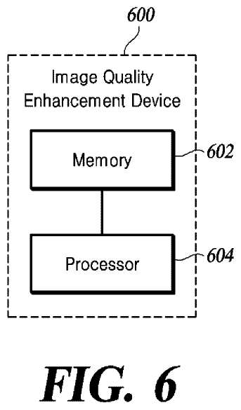

FIG. 6 is a block diagram of an image quality enhancement device according to at least one embodiment of the present disclosure.

Referring to FIG. 6, an image quality enhancement device 600 includes both or one of a memory 602 and a processor 604.

The memory 602 may store a program that is executable by the processor 604 to cause an image quality enhancement method to be performed according to at least one embodiment of the present disclosure. For example, the program may include a plurality of instructions executable by the processor 604, and the plurality of instructions may be executed by the processor 604 to perform the image quality enhancement method.

The memory 602 may include at least one of the volatile memory and non-volatile memory. The volatile memory may include, for example, static random access memory (SRAM) or dynamic random access memory (DRAM) among others, and the non-volatile memory may include, for example, flash memory among others.

The processor 604 may include at least one configuration capable of executing at least one instruction. The processor 604 can execute the instructions stored in the memory 602, and by executing the instructions, the processor 604 can perform the image quality enhancement method according to the present disclosure.

Various illustrative implementations of the device and method described herein may be realized by digital electronic circuitry, integrated circuits, field-programmable gate arrays (FPGAs), application-specific integrated circuits (ASICs), computer hardware, firmware, software, and/or their combination.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Further, the computer-readable recording medium can be distributed in computer systems connected via a network, wherein the computer-readable codes can be stored and executed in a distributed mode.

Although the respective steps in the sequence diagrams/flowcharts are described to be sequentially performed, they merely instantiate the technical idea of some embodiments of the present disclosure. Therefore, a person having ordinary skill in the pertinent art could perform the steps by changing the sequences described in the sequence diagrams/flowcharts or by performing two or more of the steps in parallel, and hence the steps in the sequence diagrams/flowcharts are not limited to the illustrated chronological sequences.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, network equipment, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. An image quality enhancement method optimized for distortion characteristics of a target image, the image quality enhancement method comprising:
generating one or more training datasets with one or more distortions;
obtaining training distortion characteristic values respectively by inputting the one or more training datasets into a degradation encoder neural network (DEN);
obtaining a service distortion characteristic value by inputting a service dataset comprising image patches of the target image into the degradation encoder neural network;
computing a similarity between each of the training distortion characteristic values and the service distortion characteristic value; and
selecting the training dataset having a highest similarity to the service distortion characteristic value.

2. The image quality enhancement method of claim 1, further comprising:
training a super-resolution neural network (SRN) based on the selected training dataset; and
converting the target image to a high-quality image by using the super-resolution neural network.

3. The image quality enhancement method of claim 1, wherein the training distortion characteristic value is an average of outputs of the degradation encoder neural network for at least one or more samples selected from each training dataset, and
wherein the service distortion characteristic value is an average of outputs of the degradation encoder neural network for at least one or more samples selected from the service dataset.

4. The image quality enhancement method of claim 1, wherein the similarity is calculated based on a difference between each of the training distortion characteristic values and the service distortion characteristic value.

5. A computer-readable recording medium storing instructions for causing, when executed by a computer, the computer to perform the image quality enhancement method according to claim 1.

6. A image quality enhancement method optimized for distortion characteristics of a target image, the image quality enhancement method comprising:
training, by using training datasets with different distortions, one or more super-resolution neural networks (SRNs) to be respectively optimized for a certain distortion;
computing, by using a degradation encoder neural network (DEN), a similarity between a service dataset and each of the training datasets that are applied respectively to the one or more super-resolution neural networks;
selecting, among the one or more super-resolution neural networks, a super-resolution neural network trained with a training dataset having a highest similarity; and
converting the target image into a high-quality image by using the selected super-resolution neural network.

7. The image quality enhancement method of claim 6, wherein the computing of the similarity comprises:
obtaining, by using the degradation encoder neural network, training distortion characteristic values each represent a characteristic of distortion of each training dataset that is applied to each of the super-resolution neural networks, and a service distortion characteristic value that is a value represent a characteristic of distortion of the service dataset; and
calculating the similarity based on a difference between each of the training distortion characteristic values and the service distortion characteristic value.

8. The image quality enhancement method of claim 7, wherein the training distortion characteristic value is an average of outputs of the degradation encoder neural network for at least one or more samples selected from each training dataset, and
wherein the service distortion characteristic value is an average of outputs of the degradation encoder neural network for at least one or more samples selected from the service dataset.

9. A computer-readable recording medium storing instructions for causing, when executed by a computer, the computer to perform the image quality enhancement method according to claim 6.

10. A image quality enhancement device optimized for distortion characteristics of a target image, the image quality enhancement device comprising:
a memory configured to store one or more instructions; and
a processor,
wherein the processor is configured to execute the one or more instructions for performing the steps of:
training, by using training datasets with different distortions, one or more super-resolution neural networks (SRNs) to be respectively optimized for a certain distortion;
computing, by using a degradation encoder neural network (DEN), a similarity between a service dataset and each of the training datasets that are applied respectively to the one or more super-resolution neural networks;
selecting, among the one or more super-resolution neural networks, a super-resolution neural network trained with a training dataset having a highest similarity; and
converting the target image into a high-quality image by using the selected super-resolution neural network.
